(19) United States
(12) Patent Application Publication
(10) Pub. No.: US 2025/0037612 A1
(43) Pub. Date: Jan. 30, 2025

(54) VASCULAR FLOW SIMULATION DEVICE

(71) Applicant: Life Model Designs LLC, Marengo, OH (US)

(72) Inventor: Sean Gerke, Marengo, OH (US)

(21) Appl. No.: 18/787,342

(22) Filed: Jul. 29, 2024

Related U.S. Application Data
(60) Provisional application No. 63/515,966, filed on Jul. 27, 2023.

(51) Int. Cl. G09B 23/30; G09B 23/32

(52) U.S. Cl. CPC G09B 23/303; G09B 23/32

(57) ABSTRACT

A device is described that provides simulated vascular flow. The device includes connection points for receiving and providing model blood to one or more model blood vessels. In one example of the device of the present invention, a peristaltic pump causes model blood to flow from an outlet, and through a model blood vessel towards one or more connection points. The connection point(s) may allow the model blood to flow to other model blood vessels. The model blood vessel may be attached to an apparatus contained by one or more support platforms.

### CROSS-REFERENCE TO RELATED APPLICATIONS

This non-provisional patent application claims priority to U.S. Provisional Patent Application No. 63/515,966, filed Jul. 27, 2023, the disclosure of which is incorporated by reference as if fully recited herein.

### TECHNICAL FIELD

The present invention relates generally to a device for simulating vascular flow, and more particularly to a vascular flow simulator having various connection points for receiving and providing model blood simulant to one or more model blood vessels. In one example embodiment, a peristaltic pump is configured to cause model blood simulant to flow from an outlet, and through a model blood vessel towards one or more connection points. The model blood vessel may be secured to an apparatus contained by one or more support platforms, and the connection points permit model blood simulant to flow to subsequent model blood vessels.

### BACKGROUND AND SUMMARY OF THE INVENTION

Traditionally, the study of human and animal biological pathways, namely neurovascular pathways, has been limited by the need to prevent adverse health effects on living subjects, and by the lack of neurovascular flows in deceased subjects. Known neurovascular pathway education and treatment training methods or techniques lack realistic and accurate simulation and/or modeling of actual neurovascular pathways.

The aforementioned shortcomings speak to the need for biological flow modeling that accurately mimics real life vascular or neurovascular flows. Said accurate mimicking of real life vascular or neurovascular flows may, for example, improve cardiovascular and neurovascular system education, and related surgical training. In view of this, it is beneficial to have a vascular flow simulation device and a corresponding method for assembling a vascular flow simulator.

According to the present invention in one aspect, a vascular flow simulation device comprises a housing (e.g., comprising cast urethane) containing various electronic components (e.g., peristaltic pump, temperature control device) therein. Model blood simulant may be discharged from the housing through an outlet. A vascular model apparatus containing a model blood vessel may be secured to the device (e.g., by being mated to and/or positioned on apparatus support platforms). A tank inside the housing may be configured to store model blood simulant (also referred to herein as “model blood”). A pump may be configured to cause flow of the model blood through any number of different model blood vessels. Connection points downstream of an initial model blood vessel may permit model blood flow to subsequent model blood vessels. Model blood simulant may be returned to the pump through an inlet in the housing. Various electronic components of the device may be controlled by a control unit.

It will be apparent to one of ordinary skill in the art that exemplary embodiments of the present invention provide any number of different advantages. Exemplary embodiments may be advantageous for cardiovascular and neurovascular system education, and related surgical training (e.g., a complete endovascular system may be modeled using an exemplary embodiment, permitting simulation of treatment of an actual human or animal endovascular system). Exemplary embodiments may also be advantageous for other purposes in addition to cardiovascular and neurovascular system education and related surgical training.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an exemplary vascular flow simulation device of the present invention;

FIG. 2 illustrates a perspective view of the device of FIG. 1 having a vascular model apparatus installed therein;

FIG. 3 illustrates a top plan view of the vascular model apparatus of FIG. 2;

FIG. 4 illustrates a top plan view of the device of FIG. 2;

FIG. 5 illustrates a left-side elevational view of the device of FIG. 2;

FIG. 6 illustrates a perspective view of another exemplary vascular flow simulation device of the present invention;

FIG. 7 illustrates a top plan view of the device of FIG. 6;

FIG. 8 illustrates a right-side elevational view of the device of FIG. 6;

FIG. 9 illustrates a left-side elevational view of the device of FIG. 6;

FIG. 10 illustrates an exemplary peristaltic pump of an exemplary vascular flow simulation device of the present invention;

FIG. 11 illustrates a top plan view of the device of FIG. 6 having a pump control;

FIG. 12 illustrates a front, elevational view of the device of FIG. 6;

FIG. 13 illustrates a perspective, cross-sectional view of the device of FIG. 6; and

FIG. 14 illustrates a perspective view of another exemplary vascular flow simulation device of the present invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

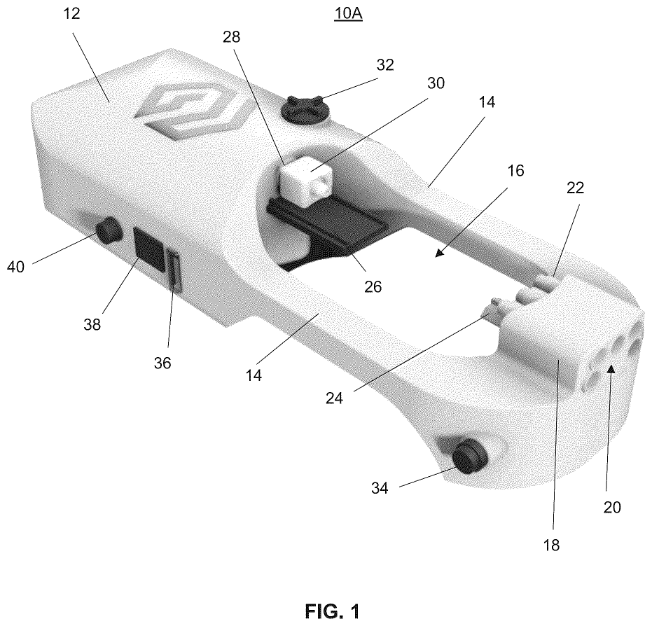

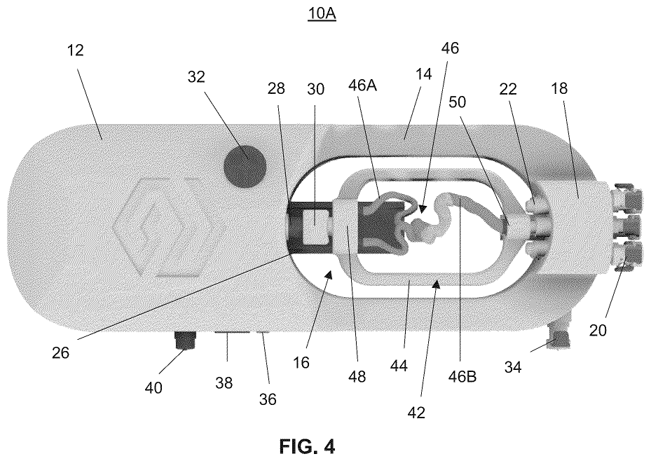

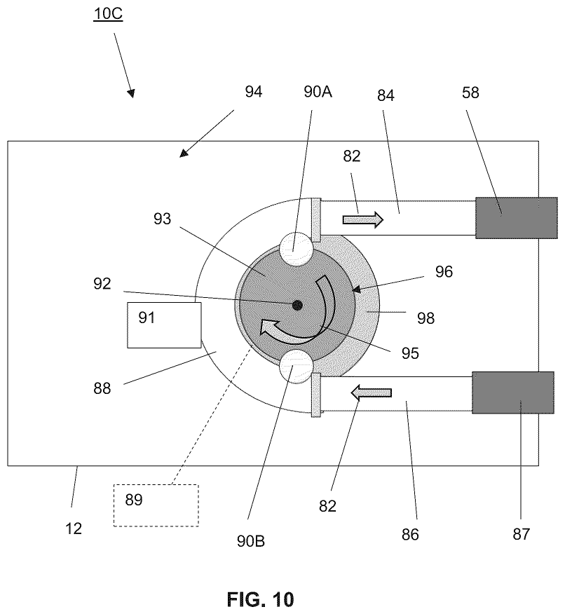

Referring now to FIGS. 1-2 and 4-5, an exemplary vascular flow simulation device 10A (also referred to herein as a “flow station”) comprises a housing 12 surrounding an interior portion of the device 10A, wherein at least one pump, motor, and fluid temperature control device may be positioned in the interior portion. The interior portion may further include a fluid tank (not shown) configured to retain model blood simulant and provide model blood simulant to a model vascular flow circuit. The housing 12 may comprise any number of different substantially rigid materials, including by way of example and not limitation, cast urethane, moldable plastic, moldable composite material, some combination thereof, or the like. Model blood simulant may be discharged from the housing 12 through an outlet 28 into a vessel connector 30. Referring to FIG. 10, model blood may be returned to the housing 12 through an inlet 87.

Referring again to FIGS. 1-2 and 4-5, a fluid level window 36 may provide a user visibility of fluid volume in the fluid tank. Thus, the fluid level window 36 may permit a user to observe whether fluid level in the tank meets a desired fluid level. The fluid tank may be configured to store up to 675 mL of fluid. Fluid, including by way of example and not limitation, model blood (e.g., as opposed to actual blood), may be introduced to the fluid tank through a port below a tank lid 32. The tank lid 32 may include a plurality of threads configured to be received by corresponding threads of the port to permit the lid 32 to be secured to the port. The flow station 10A may further comprise a receptacle region configured to receive a vascular model apparatus 42. In this particular embodiment, the receptacle region is defined by an aperture 16 substantially surrounded by a pair of beams 14, the vessel connector 30, a first apparatus support platform 26, a second apparatus support platform 24, and a connection portion 18 having connection portion inlets 22 and outlets 20.

Here, the connection portion outlets 20 are positioned on the connection portion 18 opposite of the aperture 16. The beams 14 and connection portion 18 may comprise similar or identical material to the material defining the housing 12 (e.g., cast urethane, moldable plastic, moldable composite material, some combination thereof, or the like). The connection portion 18 may be elevated with respect to the beams 14 to, e.g., permit a plurality of channels to be positioned in the connection portion 18 immediately downstream of a model blood vessel 46 at a similar height to that of the model blood vessel 46. The connection portion inlets 22 and outlets 20 may each be equipped with a valve to permit user adjustment of flow through the inlet 22 or outlet 20.

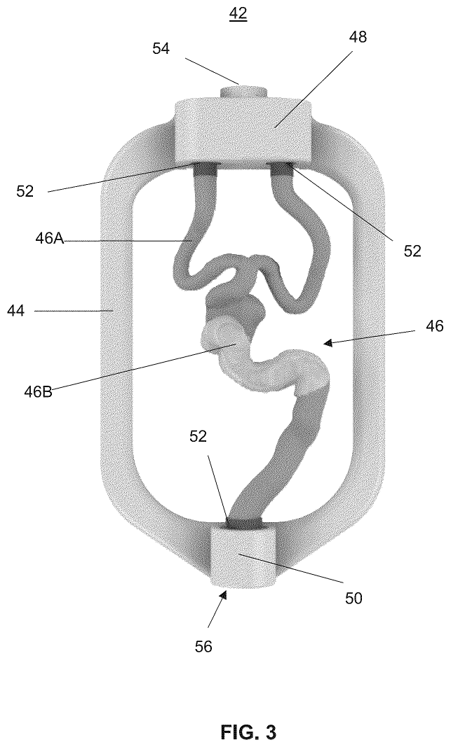

Referring to FIGS. 1-5, the flow station 10A may be configured to secure a vascular model apparatus 42 in the receptacle region to, e.g., integrate the model blood vessel 46 in the model vascular flow circuit, and permit a user to approach and/or interact with the model blood vessel 46 from any number of different angles/directions. The vascular model apparatus 42 may comprise a substantially rigid, oval-shaped frame 44 having an inflow connector 48 and an outflow connector 50 affixed thereto. In this particular embodiment, an inflow channel attachment 54 of the inflow connector 48 is configured to be received by the vessel connector 30 to connect the inflow connector 48 to the flow station 10A, and permit outbound model blood flow from the outlet 28 to be transferred through the vessel connector 30 to the inflow connector 48. An outflow channel 56 of the outflow connector 50 may be configured to receive a protruding connection portion inlet 22 to connect the outflow connector 50 to the flow station 10A, and to cause model blood flowing out of the model blood vessel 46 to be directed into the connection portion 18. Ends 52 of the model blood vessel 46 may be epoxied to the connectors 48, 50.

Any number of different model blood vessels of any number of different shapes, thicknesses, lengths, diameters, and the like, and having any number of different ends, conversion points, curvatures, pathways, and the like may be secured in an exemplary vascular model apparatus. In this particular embodiment, the model blood vessel 46 of apparatus 42 includes two smaller vessels 46A converging on one larger vessel 46B. Pressurization of the model blood (e.g., by a pump in the housing 12) causes the model blood to flow from the inflow channel attachment 54 to the outflow channel 56, through the model blood vessel 46 from 46A to B. It will be apparent to one of ordinary skill in the art that there may be any number of different techniques available for securing each end of an exemplary model blood vessel to a connector (e.g., 48, 50) of an exemplary vascular model apparatus without departing from the scope of the present invention. As a specific, non-limiting example, epoxying of the model blood vessel 46 to the connectors 48, 50 may be achieved by applying an epoxy resin to each end 52 of the vessel 46, and then placing each end 52 in a channel of the corresponding connector 48, 50.

The vascular model apparatus 42 may further be secured to the device 10A within the receptacle region by mating at least one connector (e.g., 48) of the apparatus 42 to an apparatus support platform (e.g., 26). In this particular embodiment, the first apparatus support platform 26 includes a plurality of ridges each adapted to be received by a corresponding channel on the bottom of the inflow connector 48 to secure the inflow connector 48 to the first apparatus support platform 26. The inflow connector 48 may be slid over the first apparatus support platform 26 to secure a portion of each ridge of the platform 26 in the corresponding channel of the connector 48. In the embodiment shown, the second apparatus support platform 24 is configured to provide base support to the outflow connector 50. It will be apparent to one of ordinary skill in the art that any number of different devices and/or techniques may be employed for securing an exemplary vascular model apparatus to an exemplary flow station without departing from the scope of the present invention.

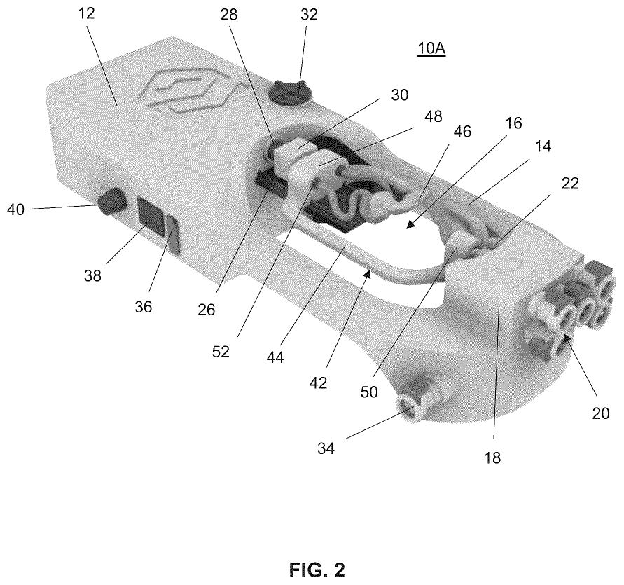

An exemplary model vessel may be configured to imitate any number of different biological pathways, including vascular and/or neurovascular pathways. The vessel connector 30 may be repositioned along a protrusion of the outlet 28 to, e.g., accommodate varying lengths of vascular model apparatus frames. For example, a smaller vascular model apparatus (e.g., with respect to distance between connectors 48 and 50) may be provided for user interaction with a smaller biological pathway. An exemplary vascular model apparatus is also not necessarily limited to a single inflow channel attachment (e.g., 54) of the inflow connector (e.g., 48) and a single outflow channel (e.g., 56) of the outflow connector (e.g., 50). The vascular model apparatus connectors may each include any number of different channels to accommodate any number of different ends (e.g., 52) of an exemplary model blood vessel. A flow station 10A may also comprise more than one outlet 28 in alternative embodiments (e.g., to simulate flow from a plurality of arteries). A vascular model apparatus 42 may also connect to more than one connection portion inlet (e.g., multiple available connection portion inlets 22 are shown in FIGS. 1-2) in alternative embodiments.

The model blood vessel 46 may comprise any number of different materials, which may mimic the characteristics of walls of a real blood vessel. By way of example and not limitation, a model blood vessel may comprise transparent PVC, nylon, polystyrene, polyurethane, some combination thereof, or the like. The model blood vessel 46 may be assembled using any number of different additive manufacturing techniques, including, by way of example and not limitation, VAT photopolymerization, material jetting, binder jetting, laser sintering, material extrusion, some combination thereof, or the like. Additive manufacturing employed may involve a 3D printer. As a non-limiting example, a Stratasys® J850™ Digital Anatomy™ or Stratasys® J750™ Digital Anatomy™ 3D printer may be provided to contribute to the assembly of a model's simulated biological pathway. It will be apparent to one of ordinary skill in the art that an exemplary flow station is also not limited to use with a model blood vessel, and any number of different model biological (e.g., neurovascular) pathways may be employed without necessarily departing from the scope of the present invention.

An exemplary technique for assembling a model blood vessel involves the application of both computer-aided design (CAD) and 3D-printing. Imagery of an actual blood vessel or combination of blood vessels may be generated by way of a CT/CTA scan, MRI/MRA, vascular ultrasound, some combination thereof, or the like. The imagery may be communicated to a CAD software program. The specific configuration of the actual blood vessel or combination of blood vessels may be replicated as a 3D digital rendering in the CAD software program. The CAD software program may be adapted to translate the specific configuration of the blood vessel(s) to printing instructions for a 3D printer. As a non-limiting example, Materialize Mimics™ software may be employed to provide and communicate biological pathway specifications to a Stratasys® J850™ Digital Anatomy™ 3D printer. The 3D printer may print one or more model blood vessels mimicking the specific configuration of the actual blood vessel or combination of blood vessels.

The printed model blood vessel(s) may reflect various features of the actual blood vessel or combination of blood vessels, such as, for example, defects or abnormalities in the blood vessel(s). Exemplary 3D printing may demonstrate a margin of error within 0.3 mm-0.7 mm with respect to replicating a patient's actual unique vasculature. A user (e.g., surgeon or surgeon in training) may practice interacting with the model blood vessel(s) (e.g., mock/practice surgery) before interacting with the actual blood vessel(s) (e.g., actual surgery). As a non-limiting example, a model blood vessel may simulate arteriovenous malformations (AVMs) of an actual blood vessel. A user (e.g., a vascular surgeon or specialist) may practice treating exemplary model AVMs before treating actual AVMs of a human patient for which the model AVMs are based off of. An advantage to first interacting with model blood vessels before interacting with actual blood vessels (for which the model blood vessels may be based off of) is that the user may become familiarized with the actual blood vessels before engaging and/or altering them. An exemplary model blood vessel may mimic each actual anatomical vascular layer of an actual blood vessel. Each layer may comprise a unique imprinted characteristic for promoting replication accuracy.

The flow station 10A may be configured to cause flow in a model vascular system by providing a means for pressurizing fluid in said system (e.g., similar to a heart causing blood flow in human or animal blood vessels). An advantage to having model blood flow and pressure mimicking that of actual blood flow and blood pressure in a human or animal is that it may provide a user (e.g., cardiovascular surgeon in training) the opportunity to observe and/or interact with a realistic model vascular system without the risk of potential adverse health effects being suffered by an actual patient.

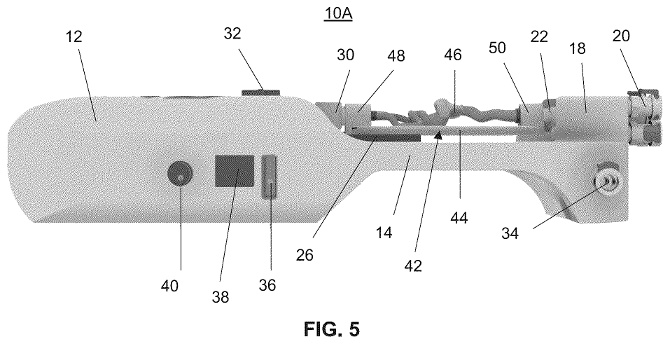

Referring now to FIG. 10, a pump 96 positioned in an interior portion 94 of an exemplary flow station 10C may be configured to circulate model blood 82 (and/or any number of different other fluids mimicking fluid of a vascular, neurovascular, or other biological pathway) through a model blood vessel (e.g., 46 in FIG. 5). The model blood vessel may be in fluid communication with output tubing 84 of the device 10C. The output tubing 84 may be configured to discharge fluid from the interior portion 94 through outlet 58. Input tubing 86 may be configured to draw in fluid into the interior portion 94 through inlet 87. Input 86 and output 84 tubing may comprise PVC, nylon, polystyrene, polyurethane, some combination thereof, or the like.

The pump 96 may comprise a peristaltic pump (e.g., Kamoer® peristaltic pump). The pump 96 may include a rotor 93 having at least two wipers or rollers 90A-B, each configured to apply compressive force to a region 88 of a fluid circuit upstream of a vascular model apparatus (e.g., 42 in FIG. 5). Said region 88 may be u-shaped, and may also comprise PVC, nylon, polystyrene, polyurethane, some combination thereof, or the like. Said fluid circuit may comprise the region 88, input tubing 86, output tubing 84, inlet 87, outlet 58, a model blood vessel, and the like.

The rotor 93 may be connected to an electric motor 98 configured to cause rotation (e.g., demonstrated by arrow 95) of the rotor 93 about a central axis 92. Each the rotor 93 and the motor 98 may be positioned inside the housing 12 of the flow station 10C proximate to the inlet 87 and outlet 58. The motor 98 may be in electronic communication with an internal and/or external power supply. In an exemplary embodiment, a first compressive force is applied by a first wiper or roller 90A of the rotor 93 to a u-shaped flexible tubing region 88 of the fluid circuit to create a pressure gradient in said region. Said pressure gradient may cause model blood 82 to be drawn in to said region 88 from input tubing 86. A second compressive force may be applied by a second wiper or roller 90B of the rotor 93 to said region 88 to force model blood 82 out of said region 88 into the output tubing 84 to be discharged through the outlet 58. Referring back to FIG. 5, model blood flowing out of the outlet 28 may flow into a vessel connector 30 at a desired specific pressure. A pump controller may be used to specify the desired fluid pressure in the model blood vessel 46. A specified fluid pressure in the model blood vessel 46 may mimic an actual blood pressure (e.g., 60 mmHg-180 mmHg).

Referring again to FIG. 10, the pump controller 89 may be configured to adjust the amount of force applied by the rotor wipers or rollers 90A-B to the fluid circuit (e.g., at 88) to, e.g., adjust the fluid pressure and/or flow rate of the model blood 82. The pump controller 89 may also be configured to adjust the motor 98 speed (and thus the rotational speed of the rotor 93) and/or rotation direction (e.g., 95) to, e.g., regulate flow velocity. The pump controller 89 may comprise or otherwise be interacted with using one or more processors, including by way of example and not limitation, internal microprocessors, computers remote from the device 10C, some combination thereof, or the like.

Referring back to FIGS. 1-2 and 4-5, the pump controller may alternatively or additionally comprise one or more motor control buttons and/or dials positioned directly on the device. In the embodiment shown, the pump controller comprises a rotatable dial 40 that may permit a user to increase flow rate of model blood by rotating the dial 40 a first direction, and decrease flow rate of model blood by rotating the dial 40 a second direction opposite of the first direction. A screen 38 may permit a user to observe relevant data related to the device 10A including by way of example and not limitation, fluid flow rate, fluid pressure, flow velocity, fluid temperature, fluid volume, some combination thereof, or the like. As a specific, non-limiting example, the user may rotate the dial 40 to adjust the pump until the screen 38 indicates that the fluid pressure (e.g., measured in the fluid circuit by any number of different pressure sensors) in the device 10A reflects standard human blood pressure. It will be apparent to one of ordinary skill in the art that the present invention is not intended to be limited to the use of a single peristaltic pump, and additional or alternative devices/techniques for causing model blood flow may be employed without departing from the scope of the present invention.

A screen remote from the device 10A may additionally or alternatively be provided. An exemplary screen may comprise an electronic display capable of providing a configurable interface, which may permit interaction with an exemplary software module. Exemplary software instructions may be executed by one or more processors. Software instructions of an exemplary software module may regulate the operation of an exemplary device, although such is not required. Information about model blood flow characteristics, device operation, some combination thereof, or the like may be stored and/or communicated to one or more system users by way of any number of different computer readable mediums. It will be apparent to one of ordinary skill in the art that the present invention is not intended to be limited to any particular type and/or number of screens, processors, or other electronic components.

The flow station 10A may further comprise a fluid temperature control unit positioned inside the housing 12. Referring again to FIG. 10, the fluid temperature control unit 91 may be positioned in the interior portion 94 of the flow station, and may be in thermal communication with the fluid circuit (e.g., may directly or indirectly transfer heat to and from the u-shaped region 88). The fluid temperature control unit 91 may be configured to permit user regulation of the temperature of model blood 82 flowing through the flow station 10C and any model biological pathways connected to the flow station 10C. As a non-limiting example, the fluid temperature control unit 91 may be used to heat model blood to a standard body temperature (e.g., approximately 37° C. or 98° F.). The fluid temperature control unit 91 may be adjusted by way of a user engaging one or more temperature control unit adjustment buttons and/or dials positioned directly on the device 10C, an interface of an internal microprocessor of the device 10C, an interface of a computing unit remote from the device 10C, some combination thereof, or the like. The same control unit (e.g., 89) may be employed for permitting regulation/adjustment of all electronic components of the device 10C, including, for example, both the temperature control unit 91 and the motor 98, although such is not required.

The fluid temperature control unit 91 may comprise one or more thermoelectric modules in thermal communication with the fluid circuit (e.g., at 88). By way of example and not limitation, an amount of conductive heat sink material may be in contact with both the fluid circuit and the thermoelectric module. The heat sink material may be adapted to be heated by the thermoelectric module to increase model blood temperature, and may be configured to be cooled by the thermoelectric module to decrease model blood temperature. The fluid temperature control unit 91 may alternatively or additionally comprise a heat exchanger. The fluid temperature control unit 91 may be in electronic communication with a power source internal to and/or external from the flow station 10C. It will be apparent to one of ordinary skill in the art that the present invention is not intended to be limited to any particular number and/or type of fluid temperature control units.

The model blood 82 may comprise any number of different fluids having a similar appearance, viscosity, pH, specific gravity, lubricity and/or other characteristics of actual human or animal blood. In an exemplary embodiment, model blood is substantially red in color, and model blood vessel walls are substantially transparent in color. Any number of different solid or semisolid substances may be introduced to the model blood 82 to e.g., simulate solid or semisolid masses potentially found in actual blood, and behavior thereof. As a non-limiting example, solid or semisolid masses mimicking the behavior of plaque in blood may be introduced to the model blood 82 to simulate plaque build-up on the walls of a blood vessel (e.g., to estimate how long atherosclerosis may take to occur in an actual vascular system simulated by model blood vessels). Disinfectant may be introduced to a model blood flow circuit to restrict the buildup of microorganisms in said circuit. In an exemplary embodiment, lab grade disinfectant is introduced to the circuit, and is sufficient to prevent microorganism buildup in the circuit for at least 60 model blood flow simulations.

The motor, temperature control unit, and other electronic components of the flow station 10C may be powered by the same or different power supplies. A power supply may be positioned within the housing 12, connected by wire to the electronic components in the housing 12, some combination thereof, or the like. The power supply may include a portable battery pack, a rechargeable battery, another power module, some combination thereof, or the like. A portable battery back (e.g., 12v DC Meanwell power supply, medical grade) may have a runtime of approximately 6.5 hours while the device 10C is set to provide a maximum fluid flow rate.

Referring back to FIGS. 1-2 and 4-5, a plurality of connection portion outlets 20 may permit model blood to flow from the flow station 10A and a first model blood vessel 46 to subsequent model blood vessels (not shown) in fluid communication with said outlets 20 before the model blood is circulated back to the flow station 10A. One or more of the connection portion outlets 20 may be configured to connect to and provide model blood to a model carotid artery (not shown). As a specific, non-limiting example, a user (e.g., a vascular surgeon or specialist) may observe and/or interact with model blood flow in a model carotid artery to evaluate if and how bilateral internal carotid artery occlusion may occur and/or be treated in an actual carotid artery (e.g., mimicked by the model carotid artery). One or more of the connection portion outlets 20 may be configured to connect to and provide model blood to a model vertebral artery (not shown). As a specific, non-limiting example, a user (e.g., a vascular surgeon or specialist) may observe and/or interact with model blood flow in a model vertebral artery to evaluate if and how vertebral artery stenosis may occur and/or be treated in an actual vertebral artery (e.g., mimicked by the model vertebral artery).

The ability of an exemplary flow station 10A to integrate a plurality of vessels may permit a user to use the flow station 10A to create a partial or entire model vascular system comprising any number of different biological pathways. An exemplary model endovascular system may provide a user (e.g., a vascular surgeon or specialist) realistic mock operation or other model biological pathway interaction scenarios without any risk to a patient. A model vascular system may include, for example, a model aortic arch, model veins, model carotids, model vertebral arteries, a model pulmonary artery, some combination thereof, or the like. Each vessel of the model vascular system may be 3D-printed. Each vessel of the model vascular system may connect directly or indirectly to a port (e.g., 20) of the flow station 10A, and may be in fluid communication with at least one pump (e.g., 96 in FIG. 10). Model blood discharged from an exemplary vessel may be directed (e.g., by one or more tubes) to a flow station inlet (e.g., 87 in FIG. 10). Each vessel may be linked to a vascular model apparatus, although such is not required. Each vessel may be positioned between an inflow channel attachment configured to be inserted into a port (e.g., 20), and an outflow channel configured to cause discharged model blood to flow into a downstream inlet, port, tubing, some combination thereof, or the like.

In this particular embodiment, an aortic arch port 34 (having an optional valve) is provided. The aortic arch port 34 may be positioned below the connection portion 18 on either side of the connection portion 18, on the side of the aperture 16 opposite of the main outlet 28. The aortic arch port 34 may be configured to connect to and provide model blood to a model aortic arch and/or descending aorta (not shown). As a specific, non-limiting example, a user (e.g., a vascular surgeon or specialist) may observe and/or interact with model blood flow in a model aortic arch to evaluate if and how aortic arch syndrome may occur and/or be treated in an actual aortic arch (e.g., mimicked by the model aortic arch).

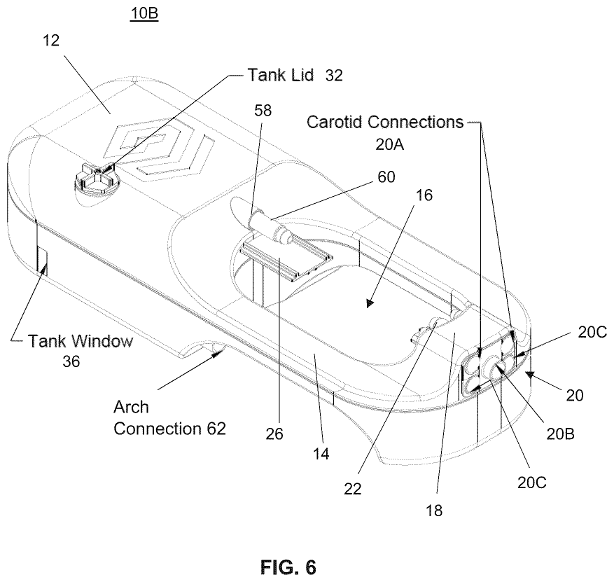

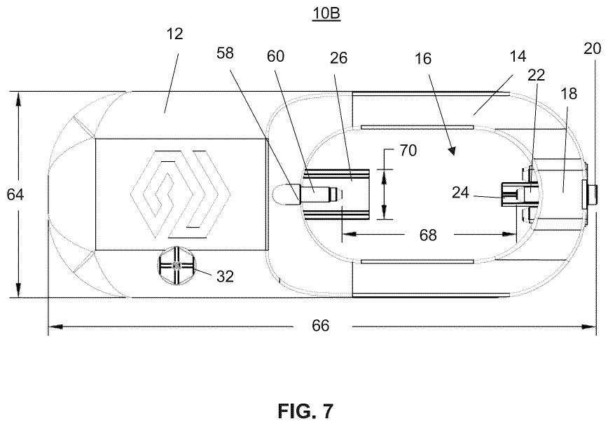

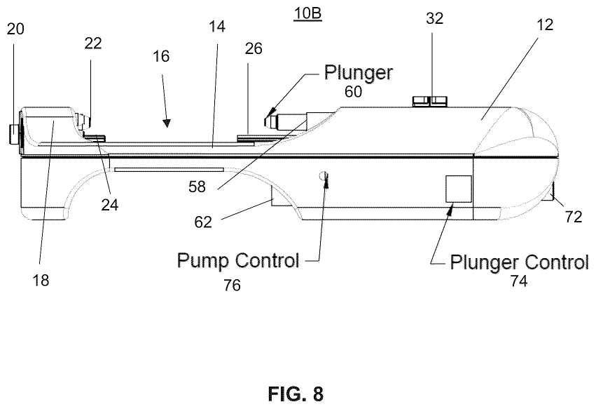

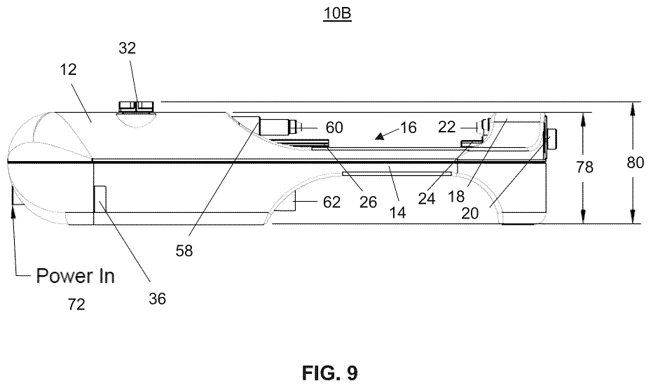

Referring now to FIGS. 6-9, an exemplary vascular flow simulation device 10B may comprise a housing 12, fluid tank (not shown) positioned below a tank lid 32, tank window 36 permitting a user to observe whether fluid level in the tank meets a desired fluid level, and an aperture 16 positioned between beams 14 each connected to curved portions of the device 10B. The housing 12 may comprise cast urethane, although such is not required. Model blood may be discharged from the housing 12 through an outlet 58. The aperture 16 may be configured to receive a vascular model apparatus (not shown), which may be secured to the device 10B by being mated to and/or positioned on apparatus support platforms 24, 26.

Here, positioned above support platform 26 and immediately downstream from outlet 58 is a plunger 60. The plunger 60 may be configured to promote flow downstream from the outlet 58. The plunger 60 may also be configured to receive an inflow connector (not shown) positioned any number of different distances from an outflow connector (not shown). Activity of the plunger 60 (e.g., flow control activity, readjustment activity to accommodate changes in the aforementioned distances) may be regulated by a plunger control unit 74. The plunger control unit 74 may comprise a digital interface, one or more buttons and/or dials on the housing 12, an internal and/or remote processor, a screen, some combination thereof, or the like. The plunger control unit 74 may be regulated by the same control unit regulating operation of other electronic components of the device 101B, although such is not required.

The plunger may be positioned a distance 68 of approximately 5.84 inches from connection portion inlets 22. The support platform 26 may have a width 70 of approximately 1.65 inches. The flow station 10B may have a length 66 of approximately 18.25 inches. The flow station 10B may have a width 64 of approximately 6.85 inches. The flow station 10B may have a height 78 measured from the bottom to the top of the housing 12 of approximately 3.73 inches. The flow station 10B may have a height 80 measured from the bottom of the housing 12 to the top of the tank lid 32 of approximately 4.09 inches. It will be apparent to those of ordinary skill in the art that variations to the aforementioned distances may be made without departing from the scope of the present invention. The flow station 10B may weigh approximately 3 pounds, although such is not required.

In this particular embodiment, a connection portion 18 comprises a number of connection portion inlets 22 and outlets 20. Model blood may flow in at least one of said inlets 22 and out through one or more of said outlets 20 towards one or more model vessels positioned downstream from the device 10B (e.g., to form a model vascular flow circuit). Here, the connection portion outlets 20 include a pair of carotid connections 20A, a main approach connection 20B, and vertebral connections 20C. The carotid connections 20A may permit model blood flow to two model carotid arteries (now shown). The main approach connection 20B may permit model blood flow to one or more subsequent model biological pathways, the main pump or a subsequent pump, a subsequent measuring or storage unit, some combination thereof, or the like. The vertebral connections 20C may permit model blood flow to two model vertebral arteries (not shown). An arch connection 62 may be positioned on either side of aperture 16. In this particular embodiment, the arch connection 62 is positioned below the outlet 58. The arch connection 62 may permit model blood flow to a model aortic arch. Each aforementioned vessel may be varied in specific configuration and/or customized based on user requirements (e.g., may be modeled to reflect the specific configuration of an actual vessel).

Model blood flow from one or more of the aforementioned vessels may be directed towards an inlet (not shown) of the device 10B to be received by a pump configured to recirculate the model blood out of outlet 58. An exemplary fluid circuit may be linked to a measuring container (e.g., 500 mL graduated polycarbonate measuring jar) to, e.g., permit measuring of the volume of model blood in or available to the fluid circuit. The pump (not shown) may be regulated by a pump control unit 76 positioned on the housing 12. The pump control unit 76 may comprise a digital interface, one or more buttons and/or dials on the housing 12, an internal and/or remote processor, a screen, some combination thereof, or the like. The pump control unit 76 may be regulated by the same control unit regulating operation of other electronic components of the device 101B, although such is not required. The device 10B may further comprise a power module (not shown) configured to provide electric power to electronic components of the device 10B. The power module may comprise a rechargeable battery. External power may be supplied to the power module through a power input port 72.

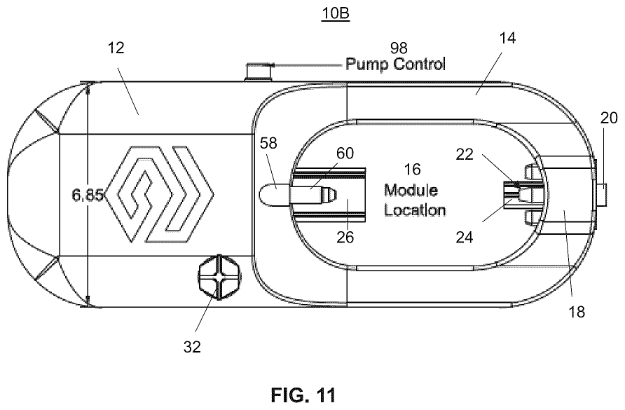

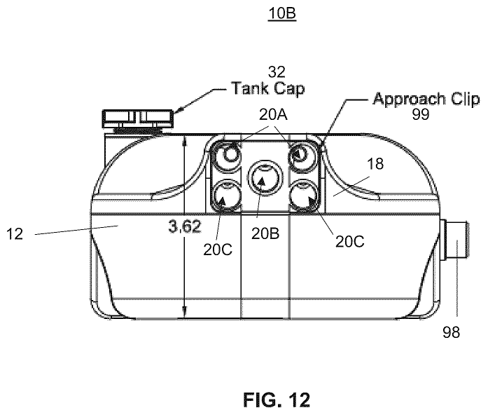

FIG. 11 shows a top, plan view of the device 10B having a housing 12, aperture 16 (e.g., for positioning a blood vessel module) tank lid 32, beams 14, outlet 58, plunger 60, support platforms 24, 26, connection portion 18 and connection portion inlets 22 and outlets 20. In this particular embodiment, the device 10B is approximately 6.85 inches wide. Here, a pump control 98 is positioned on the device 10B exterior proximate to a pump (not shown). FIG. 12 shows the particular outlets 20A-C of the connection portion 18 of the FIG. 11 embodiment. The tank cap 32, pump control 98 and device housing 12 are also visible in FIG. 12. Here, the device 10B is 3.62 inches in height. An approach clip 99 may be provided to permit subsequent model biological pathways to be connected to the connection portion 18.

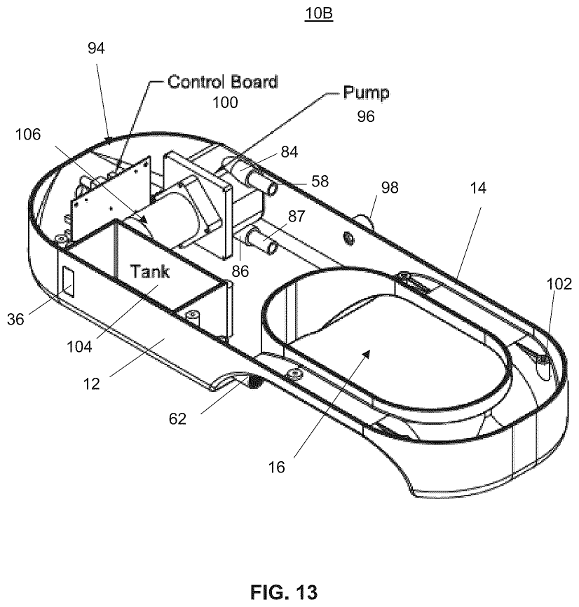

FIG. 13 shows an interior portion 94 of the device 10B having a housing 12, aperture 16 (e.g., for positioning a blood vessel module), beams 14, outlet 58, inlet 87, pump 96, output tubing 84, input tubing 86, tank window 36, arch connection 62, and pump control 98. In this particular embodiment, the pump 96 is connected to a motor shaft 106 positioned proximate to a control board 100. A tank 104 is shown proximate to the tank window 36. The tank 104 may be in fluid communication with a fluid circuit and the pump 96. Connection points 102 may be positioned across the device interior 94 to permit a lower portion and an upper portion (not shown) of the housing 12 to be connected to one another (e.g., by way of clips, inserts, fasteners, some combination thereof, or the like).

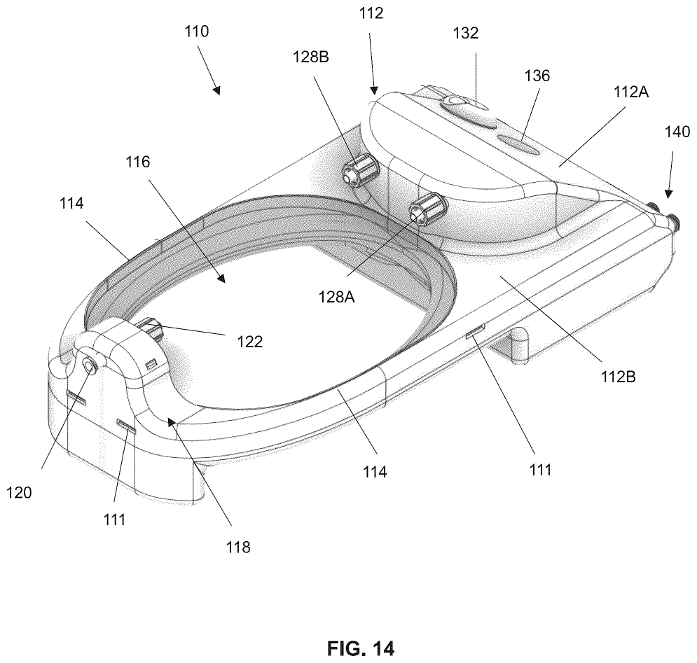

Referring now to FIG. 14, another exemplary vascular flow simulation device/flow station 110 is shown. The housing 112 of the flow station 110 may include a first portion 112A and a second portion 112B. The first portion 112A may extend above the second portion 112B, and various interior components of the flow station 110 (e.g., the motor, pump, control board, temperature control unit, and fluid tank—not shown here) may be positioned within or proximate to the first portion 112A. The device 110 may include a plurality of fluid ports 128A-B for permitting fluid (e.g., blood simulant) to circulate to and from the pump inside the housing 112. For example, model blood simulant may be discharged from the housing 112 through an outlet (e.g., 128A), and returned to the pump inside the housing 112 by way of an inlet (e.g., 128B).

Blood simulant may flow from the outlet (e.g., 128A) to a connection portion inlet 122. Blood simulant flowing from the outlet (e.g., 128A) to the connection portion inlet 122 may flow through a model blood vessel (not shown). The model blood vessel may extend in an aperture 116 directly from the outlet (e.g., 128A) to the connection portion inlet 122. Alternatively, the model blood vessel may be formed to or attached to a vascular model apparatus (not shown) positioned in the aperture 116. The aperture may be at least partially defined by a pair of beams 114 extending from a main portion of the device 110 towards a connection portion 118.

The connection portion 118 may include the connection portion inlet 122 and one or more connection portion outlets (e.g., 120). The connection portion outlet(s) may permit blood simulant to flow from the connection portion 118 to one or more model blood vessels positioned downstream of the connection portion 118. Here, the connection portion outlet 120 is positioned on the connection portion 118 opposite of the aperture 116. After flowing through model blood vessels positioned downstream of the connection portion 118, the blood simulant may flow back into an inlet towards the pump to be recirculated through a model flow circuit. A fluid level window 136 may provide a user visibility of fluid volume in the fluid tank. Fluid (e.g., blood simulant) may be introduced to the fluid tank through a port below a tank lid 132. Various inlets and outlets of the device 110 may be equipped with a valve (e.g., a rotatable valve) to permit user adjustment of flow through the inlet or outlet.

Any number of different model biological pathways (e.g., model blood vessels) of any number of different shapes, thicknesses, lengths, diameters, and the like, and having any number of different ends, conversion points, curvatures, pathways, and the like may be integrated with the device 110. The device 110 may include one or more device controls 140 (e.g., one or more buttons, dials, screens, switches, some combination thereof, or the like) for permitting a user to regulate various features of the device (e.g., fluid pressure, flow rate, flow velocity, fluid temperature, some combination thereof, or the like). The device 110 may also include one or more electronic ports 111 for powering and/or charging certain electronic components of the device.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may comprise personal computers, smartphone, tablets, databases, servers, processors, or the like, internal or external to the device, and when internal may be small or miniature size. The electronic connections and transmissions described herein may be accomplished by wired or wireless means.

What is claimed is:

1. A vascular flow simulation device, comprising:
a housing;
a first outlet, located at the housing, and configured to be in fluid communication with a model vascular flow circuit;
a pump, positioned in the housing; and
wherein the pump is configured to cause a blood simulant to be discharged from the housing through the first outlet.

2. The device of claim 1, further comprising a second outlet, wherein the first outlet is configured to discharge blood simulant towards a first model blood vessel, and the second outlet is configured to discharge blood simulant towards a second model blood vessel.

3. The device of claim 1, further comprising a temperature controller configured to adjust the temperature of the blood simulant.

4. The device of claim 1, further comprising a fluid tank positioned in the housing, the fluid tank configured to retain blood simulant and provide blood simulant to the model vascular flow circuit.

5. The device of claim 4, further comprising a fluid level window positioned proximate to the fluid tank, the fluid level window allowing a user to observe fluid volume in the fluid tank.

6. The device of claim 1, further comprising an inlet at the housing, the inlet configured to receive blood simulant from the model vascular flow circuit, and permit the blood simulant to flow towards the pump.

7. The device of claim 1, further comprising a receptacle capable of receiving a model blood vessel, the receptacle positioned downstream of the first outlet.

8. The device of claim 7, further comprising a vascular model apparatus positioned in the receptacle.

9. The device of claim 7, further comprising a second outlet, wherein the first and second outlets are positioned proximate to opposite sides of the receptacle with respect to one another.

10. The device of claim 9, further comprising a third outlet positioned proximate to the second outlet.

11. The device of claim 8, wherein the vascular model apparatus is substantially secured by at least one apparatus support platform.

12. The device of claim 7, wherein the receptacle is partially defined by a first beam and a second beam, wherein the first beam is located at an opposite side of the receptacle with respect to the second beam.

13. The device of claim 1, wherein the pump is a peristaltic pump.

14. The device of claim 1, wherein the pump is configured to be controlled by a rotatable dial.

15. The device of claim 1, further comprising a plunger positioned at the first outlet.

16. A vascular flow simulation device, comprising:
a housing;
a pump, configured to cause blood simulant to circulate through a model vascular flow circuit;
a first outlet, located at the housing, and configured to provide blood simulant to a first model blood vessel substantially mimicking behavior of a first human or animal blood vessel;
a second outlet, configured to provide blood simulant to a second model blood vessel substantially mimicking behavior of a second human or animal blood vessel;
wherein the pump is configured to cause the blood simulant to be discharged from the housing through the first outlet; and
wherein the pump is configured to cause the blood simulant to be received in an inlet downstream of the first outlet, second outlet, or both.

17. A method for assembling a vascular flow simulation device, comprising:
providing a housing;
positioning an outlet at the housing;
positioning a pump inside the housing; and
configuring the pump to cause a blood simulant to be discharged from the housing through the outlet towards a model blood vessel positioned downstream of the outlet.

18. The method of claim 17, further comprising providing the model blood vessel, and establishing fluid communication between the model blood vessel and the outlet.

19. The method of claim 18, wherein the model blood vessel is assembled using additive manufacturing.

20. The method of claim 19, wherein the model blood vessel is assembled by a 3D printer based on specifications provided by imagery of an actual blood vessel.
